(19) United States
(12) Patent Application Publication
(10) Pub. No.: US 2014/0240493 A1
(43) Pub. Date: Aug. 28, 2014

(54) SENSOR LIGHTING WITH IMAGE RECORDING UNIT

(71) Applicants: Jong Suk Bang, Hanam (KR); Ji Won Kim, Hanam (KR)

(72) Inventors: Jong Suk Bang, Hanam (KR); Ji Won Kim, Hanam (KR)

(21) Appl. No.: 13/781,193

(22) Filed: Feb. 28, 2013

(51) Int. Cl. H04N 7/18

(52) U.S. Cl. CPC H04N 7/18
USPC 348/143

(57) ABSTRACT

Disclosed herein is a sensor lighting which is installed in a building such as a dwelling. The sensor lighting according to the present invention is provided with an image recording unit that includes a sensor module, a camera module and a recording module. The sensor lighting includes a base body, a removable cover body and a light transmission body. The recording module is mounted to the base body, and the sensor module and the camera module are mounted to the removable cover body such that the sensor module and the camera module are partially exposed to the outside of the removable cover body. Therefore, the sensor lighting not only can substitute for the existing sensor lighting but can also function as an image recording device.

### BACKGROUND OF THE INVENTION

1. Field of the Invention

The present invention relates generally to sensor lightings installed in buildings such as dwellings and, more particularly, to a sensor lighting which is installed in entrances, stairs, corridors, etc. of different kinds of buildings and is provided with an internal image recording unit that includes a sensor module, a camera module and a recording module, whereby the image recording unit can be easily installed along with the sensor lighting without requiring separate wiring work in a desired place where the sensor lighting is required, and a plurality of image recording units can be provided in the single sensor lighting so that capturing or recording of images can be conducted with respect to a variety of directions, and in which a memory card is removably provided in the image recording unit so that a user can rapidly and easily check recorded data.

2. Description of the Related Art

Generally, lightings are installed in indoor or outdoor spaces of most buildings, for example, dwelling buildings such as apartment buildings, multi-unit houses, detached houses, multi-purpose buildings or hotels, and office buildings such as schools, public office buildings, commercial buildings or apartment type factories.

Particularly, sensor lightings which are operated when detecting the approach of a person are typically provided in entrances, stairs, corridors, etc. of such buildings. The sensor lightings are configured such that upon a detecting sensor detecting the approach of a person, a light source is turned on, and then it is maintained in the turned-on state for a predetermined time and then automatically turned off.

Such a sensor lighting may be operated for a whole day or only during the night, depending on the quantity of light around the sensor lighting or the purpose of use. Sensor lightings have low power consumption and can also be automatically turned on and off without using a separate switch, thus being convenient for the user.

Furthermore, recently, various types of surveillance cameras used for security purposes and crime prevention are being installed not only on the exteriors of the buildings but also in their interiors. Such a surveillance camera is fixed at a required location in the interior or on the exterior of a building. Image/video data recorded by the surveillance camera is stored in a separate recording device. As necessary, image/video data taken by the surveillance camera may be displayed on a monitor.

However, these surveillance cameras and recording devices are very expensive. Hence, most people cannot easily use surveillance cameras even though they are well aware of the necessity of surveillance cameras. Moreover, in the case where a surveillance camera is installed in an indoor space, it not only detracts from the aesthetic appearance of the space, but also causes people to feel uncomfortable.

Furthermore, to install such a surveillance camera, a power line for supplying power to the surveillance camera and a data cable for data transmission are required. If the power line and data cable have not been laid when constructing the building, they must be exposed to the outside, thus defiling the appearance of the building. Even if a separate moulding covers the power line and data cable, the moulding also reduces the decorative qualities of the interior space.

Further, the surveillance camera needs a light source such as an infrared lamp for photographing at night. Moreover, when the user wants to check recorded data transmitted from the surveillance camera, he/she must go to a place where there is a separate recording device and use a monitor connected to the recording device after manipulating the recording device. Therefore, it is cumbersome to manage, check and transfer data.

Particularly, in the case where a plurality of surveillance cameras are installed in a single building, data produced by the surveillance cameras is generally stored in a single recording device. If the recording device malfunctions or an error occurs, recorded data of all of the surveillance cameras may not be able to be stored. The existing recorded data that has been stored may also be lost. This is very problematic and risky.

Moreover, such a surveillance camera has a predetermined angle of coverage and records images with respect to a predetermined direction. If it is required to record images outside of a range given by the angle of coverage, or images with respect to a different direction, an additional surveillance camera must be used. Thus, in some cases, a plurality of surveillance cameras which are oriented in different directions may be installed in a single place. These surveillance cameras not only defile the appearance of the place but also disturb those people who are filmed by the cameras, thus negatively affecting the image of the building or the image of a company which resides in the building.

### SUMMARY OF THE INVENTION

Accordingly, the present invention has been made keeping in mind the above problems occurring in the prior art, and an object of the present invention is to provide a sensor lighting which is installed in a variety of buildings and provided with an image recording unit that includes a sensor module, a camera module and a recording module, wherein the sensor lighting includes a base body, a removable cover body and a light transmission body, and the recording module is mounted to the base body, and the sensor module and the camera module are mounted to the removable cover body such that the sensor module and the camera module are partially exposed to the outside of the removable cover body,
wherein the sensor lighting provided with the image recording unit can be used to monitor and check the interior and exterior of different kinds of buildings and to provide security, and can conduct the same functions as those of the existing surveillance camera at comparatively low costs, and several image recording units may be provided in the sensor lighting and oriented in different directions so that the single sensor lighting can carry out the recording of images with respect to different directions.

In order to accomplish the above object, the present invention provides a sensor lighting with an image recording unit, the sensor lighting including: a base body to which an LED light source provided with a converter is mounted; a light transmission cover allowing light emitted from the LED light source to transmit; and a detecting sensor detecting an approaching person, whereby when the detecting sensor detects the approaching person, the LED light source of the base body is turned on so that light emitted from the LED light source is radiated into a target space after passing through the light transmission cover, wherein a separate removable cover body is coupled to a lower end of the base body in such a way that the light transmission cover is seated onto the removable cover body, and a recording module is provided in the base body, and a camera module and a sensor module are provided in the removable cover body so that when the sensor module detects the approaching person, the camera module records images, and recorded data produced by the camera module is stored in the recording module.

A sensor lighting according to the present invention not only can substitute for the existing sensor lighting but can also function as an image recording device for recording the interior and/or exterior of a building. Because the modularized image recording device is installed in the sensor lighting, separate wiring or installation work is not required. Several image recording devices can be individually provided in the single sensor lighting. In this case, each image recording device has a removable memory card, thus facilitating checking, management and transfer of recorded data. Further, the single sensor lighting can be provided with the several image recording devices so that the recording of images can be performed with respect to different directions. The image recording devices are installed in the sensor lighting such that almost the entirety of the image recording devices are hidden from view, thus preventing them from defiling the appearance of the building, and solving a problem of causing people to have aversions to a surveillance camera.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating an embodiment of a sensor lighting according to the present invention;

FIG. 2 is a front view of the sensor lighting according to the present invention;

FIG. 3 is a sectional view of the sensor lighting according to the present invention;

FIG. 4 is an exploded sectional view of the sensor lighting according to the present invention;

FIG. 5 is an enlarged perspective view of a memory card insert slot of the sensor lighting according to the present invention;

FIG. 6 is an enlarged sectional view of a module coupling part of the sensor lighting according to the present invention;

FIG. 7 is a view showing a lighting state of the sensor lighting according to the present invention;

FIG. 8 is a view showing a recording state of the sensor lighting according to the present invention;

FIG. 9 is a perspective view illustrating another embodiment of the sensor lighting according to the present invention;

FIG. 10 is a perspective view illustrating a further embodiment of the sensor lighting according to the present invention;

FIG. 11 is a perspective view illustrating yet another embodiment of the sensor lighting according to the present invention;

FIG. 12 is a perspective view illustrating still another embodiment of the sensor lighting according to the present invention; and

FIG. 13 is a perspective view illustrating still another embodiment of the sensor lighting according to the present invention.

### DESCRIPTION OF THE PREFERRED EMBODIMENTS

The terms and words used in the specification and claims must not be limited to typical or dictionary meanings, but must be regarded as concepts selected by the inventor as concepts which best illustrate the present invention, and must be interpreted as having meanings and concepts adapted to the scope and spirit of the present invention to aid in understanding the technology of the present invention.

Hereinafter, a preferred embodiment of the present invention will be described in detail with reference to the attached drawings.

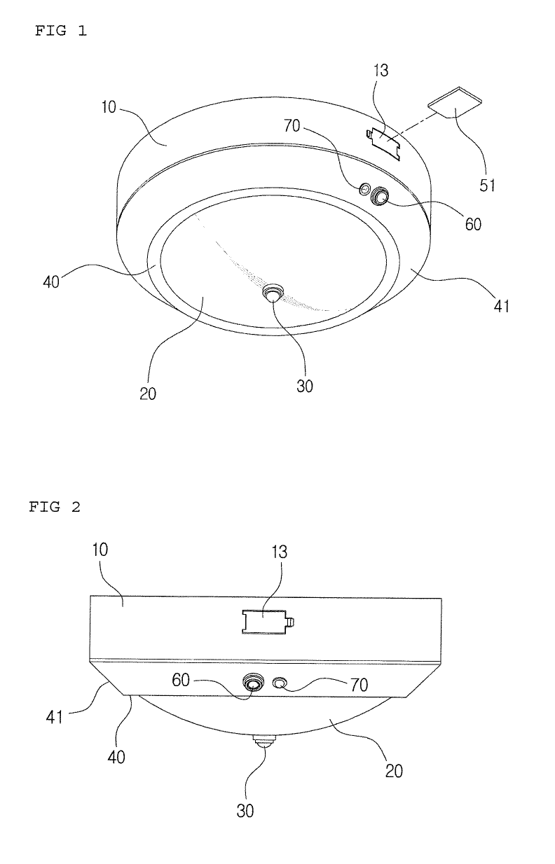

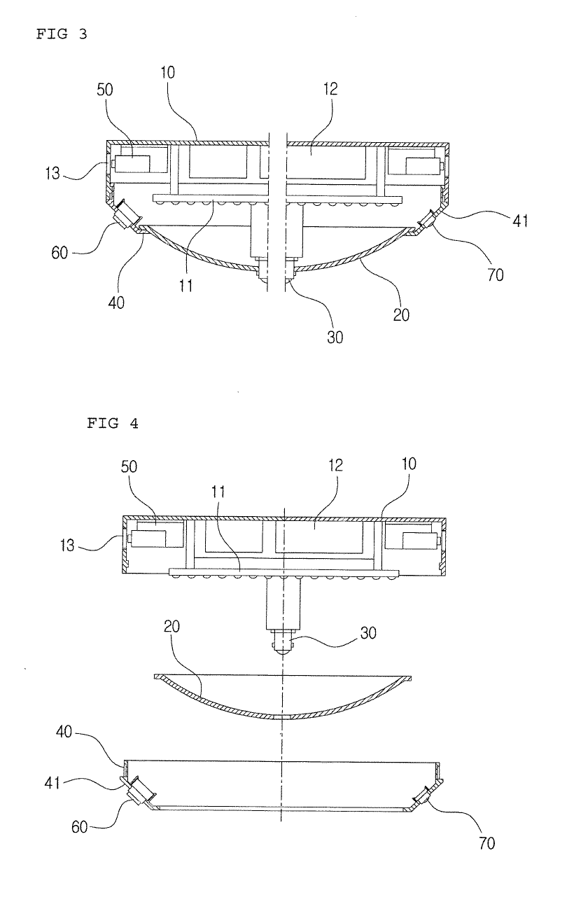

FIG. 1 is a perspective view illustrating an embodiment of a sensor lighting according to the present invention. FIG. 2 is a front view of the sensor lighting according to the present invention. FIG. 3 is a sectional view of the sensor lighting according to the present invention. FIG. 4 is an exploded sectional view of the sensor lighting according to the present invention.

As shown in the drawings, the sensor lighting according to the present invention includes a base body 10 which is directly fastened to a ceiling or embedded in the ceiling. A removable cover body 40 is removably coupled to a lower end of the base body 10 by threaded-coupling or other various locking means. A light transmission cover 20 is coupled to a lower end of the removable cover body 40.

The base body 10 can have a variety of plan shapes such as a circular or rectangular shape. An LED light source 11 is mounted in the base body 10. A separate converter 12 is installed in the base body 10 to supply power to the LED light source 11. A separate recording module 50 is disposed at a predetermined position in the base body 10.

Particularly, a detecting sensor 30 is provided in the base body 10 and is exposed to the outside of the light transmission cover 20. The detecting sensor 30 is electrically connected to the converter 12 so that when the detecting sensor 30 detects human motion, the converter 12 is operated to supply power to the LED light source 11, thereby automatically turning on the lighting.

The light transmission cover 20 is made of milk-white synthetic resin or glass and functions to diffuse light emitted from the LED light source 11 into target space.

Particularly, the removable cover body 40 has on a side surface thereof an inclined portion 41 which is reduced in width from the top to the bottom. A camera module 60 and a sensor module 70 are provided in the inclined portion 41 of the removable cover body 40 in such a way that the camera module 60 and the sensor module 70 are exposed to the outside of the removable cover body 40.

Furthermore, the perimeter of the light transmission cover 20 is placed onto the inner surface of the removable cover body 40 such that the light transmission cover 20 that has a downwardly-convex or planar shape protrudes outwards from the removable cover body 40.

As such, the sensor lighting is formed by assembling the base body 10, the light transmission cover 20 and the removable cover body 40 and is fastened to a ceiling or the like. When the detecting sensor 30 that is exposed to the outside of the lighting detects the approach of a person, the LED light source 11 is automatically turned on. The sensor module 70 detects the approach of the person separately from the detecting sensor 30 and instructs the camera module 60 to be operated to begin recording. The data recorded by the camera module 60 is stored in the recording module 50 provided in the base body 10.

Here, the camera module 60 may be configured such that it is operated in conjunction with the detecting sensor 30 provided in the base body 10 so that upon the detecting sensor 30 being operated the camera module 60 is operated. However, the sensor lighting is typically set such that it is not operated in the daytime when the quantity of light is sufficient. During this time, the camera module 60 is not operated. Therefore, it is preferable that the sensor module 70 is provided separately so that the camera module 60 can be in a recording standby state regardless of the LED light source 11 being turned on/off.

With regard to the inclined portion 41 formed in the removable cover body 40, if the camera module 60 or the sensor module 70 is provided in a vertical or horizontal surface of the removable cover body 40, the image capturing of the camera module 60 or the sensing range of the sensor module 70 becomes narrow, because it is oriented towards the ceiling or the floor/ground. Given this, in the present invention, the inclined portion 41 is provided so that the camera module 60 and the sensor module 70 can effectively capture images of a person who approaches the sensor lighting from a long distance away right up until the person is closest to the sensor lighting.

Particularly, in the present invention, an image recording unit is installed in the sensor lighting provided with the LED light source 11. In the daytime, a sufficient quantity of light is secured by the light of the sun so that images can be clearly recorded. At nighttime, when the detecting sensor 30 detects an approaching person, the LED light source 11 is turned on, so the quantity of light sufficient to record images can be secured by light emitted from the LED light source 11. Therefore, the present invention can overcome a problem of the existing CCTVs, that of deterioration of image quality or black-and-white recording.

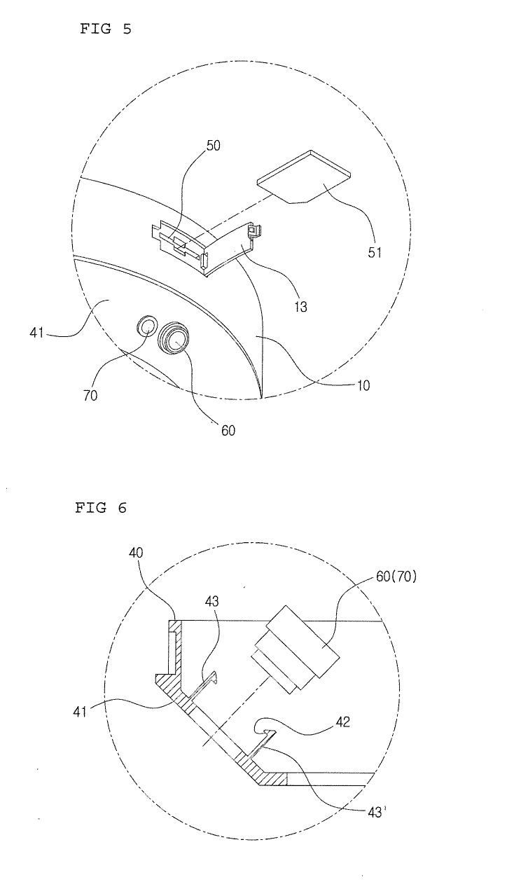

Moreover, in the sensor lighting of the present invention, an opening cover 13 is hinged to a predetermined portion of a side surface of the base body 10 so that the interior of the base body 10 can be opened or closed by rotating the opening cover 13. As shown in FIG. 5, the recording module 50 is disposed inside the base body 10 at a position corresponding to the opening cover 13.

Furthermore, a memory card 51 is removably inserted into the recording module 50. The memory card 51 stores images captured by the camera module 60. If checking, storing or transferring the recorded image data is required, a user opens the opening cover 13, pulls out the memory card 51, and then copies the data from the memory card 51, or inserts a new memory card 51 so that the recording of images can be continuously conducted.

In addition, the recording module 50 stores data in the memory card 51 in such a way that the oldest video among videos that have been stored in the memory card 51 is overwritten with a new video. As such, it is most preferable that the most recent video be stored in the memory card 51 while unnecessary past recorded data is automatically deleted in response to the capacity of the memory card 51. The memory card 51 allows the user to check a recorded video using a separate playing means. When necessary, an image can be captured from the video and output as a product such as a photograph.

Particularly, as necessary, the recording module 50 may be set such that the memory card 51 stores photographs which are successively taken by the camera module 60 rather than storing a video. If the recording module 50 is set such that the memory card 51 stores photograph data, it can store data for several months depending on the data storage capacity of the memory card 51 so that it may be more useful.

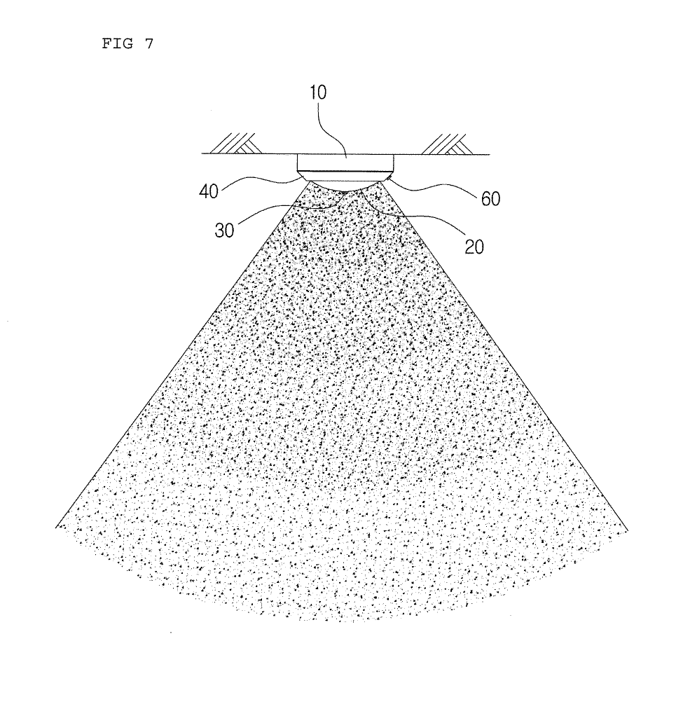

As shown in FIG. 6, the removable cover body 40 has a structure for facilitating mounting of the camera module 60 or the sensor module 70 to the removable cover body 40. In detail, locking protrusions 43 and 43′, each of which has a hook 42 on an inner surface thereof, are provided on the inner surface of the removable cover body 40. The camera module 60 or the sensor module 70 is fitted into a space between the locking protrusions 43 and 43′. Then, an end of the camera module 60 or the sensor module 70 is locked to the hooks 42 of the locking protrusions 43 and 43′ so that it can be reliably fastened to the removable cover body 40.

Here, the hook 42 which is provided on each locking protrusion 43, 43′ must be disposed at a position corresponding to the distance from the inner surface of the removable cover body 40 to the end of the camera module 60 or the sensor module 70.

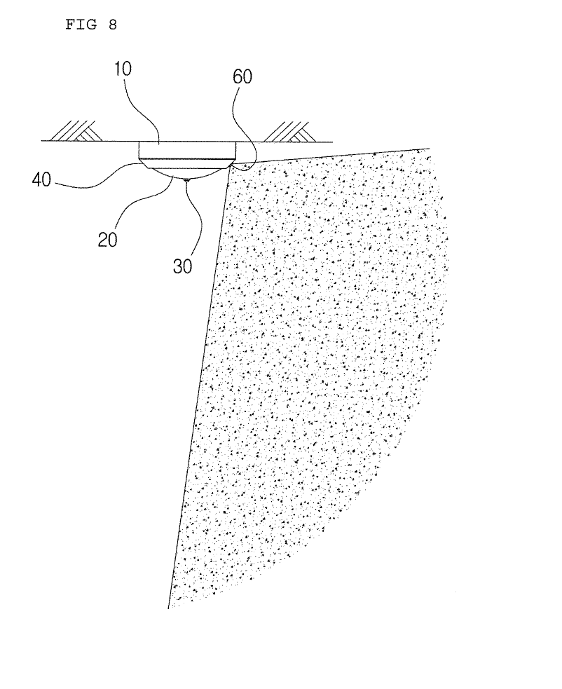

As shown in FIG. 7, when a person approaches the sensor lighting of the present invention, the detecting sensor 30 detects the approach of the person so that the LED light source 11 is turned on by the converter 12, thus lighting the target space. In a separate incident, as shown in FIG. 8, when the sensor module 70 detects the person, the camera module 60 is automatically operated to begin recording and store it in the recording module 50.

Furthermore, the sensor lighting of the present invention is provided with the image recording unit that uses the recording module 50, the camera module 60 and the sensor module 70. Therefore, the sensor lighting combines both the function of the existing sensor lighting and a function of a recording device for recording, for example, images of the indoor and/or outdoor space of a building. Here, only a single image recording unit may be used. Alternatively, as shown in FIG. 9, two image recording units may be provided on opposite sides of the sensor lighting so that the recording of images can be carried out with respect to the directions opposite to each other.

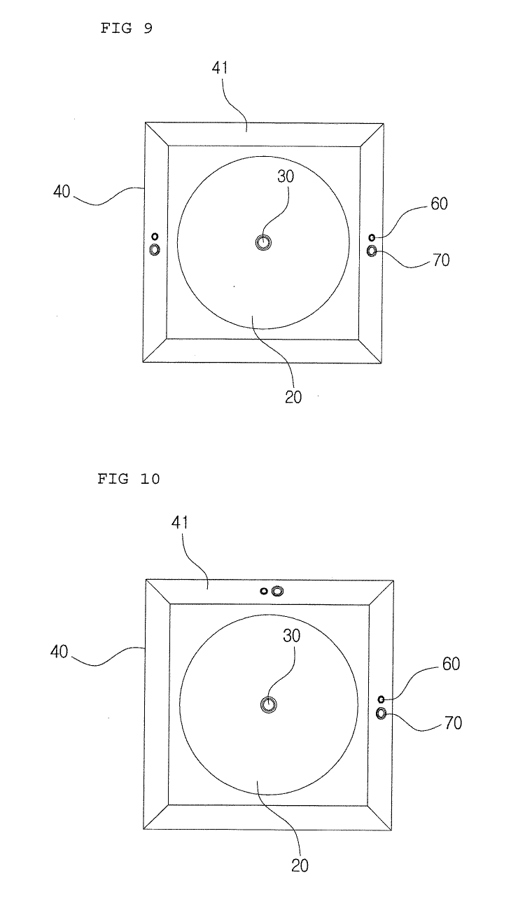

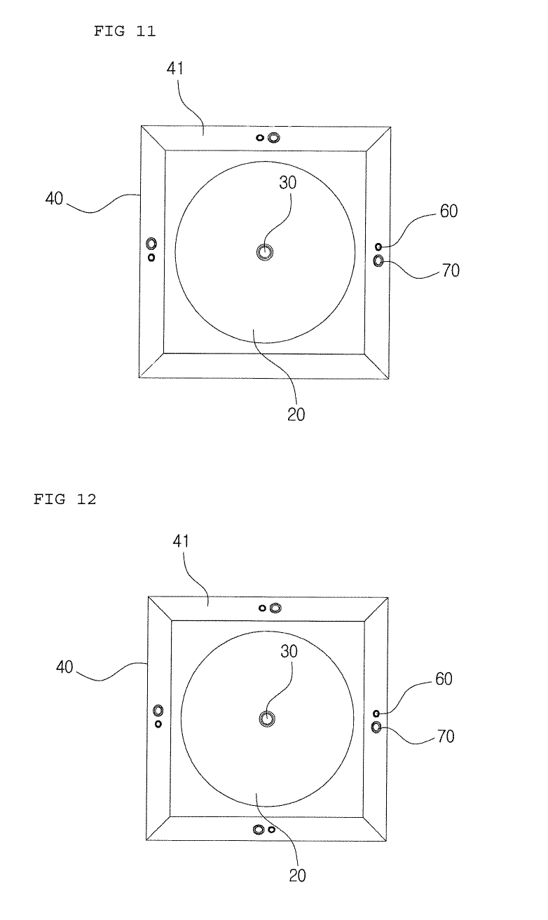

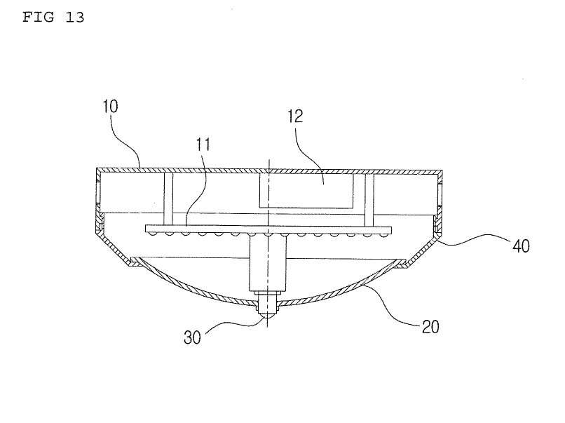

As a further alternative, as shown in FIG. 10, the image recording units may be provided such that recording images is performed with respect to the directions perpendicular to each other. As a further alternative, the image recording unit may be configured such that, as shown in FIG. 11, recording images is conducted individually or simultaneously with respect to three directions, or as shown in FIG. 12, with respect to four directions.

Thereby, the single sensor lighting can conduct the recording of images with respect to a single direction or at least two directions individually or simultaneously. The user can individually check images that have been recorded by each image recording unit.

As described above, the sensor lighting according to the present invention not only can reliably conduct its intrinsic function but can also provide the same function as the existing surveillance camera. The sensor lighting can be easily installed without requiring separate wiring work or expensive installation cost. Therefore, the present invention makes it possible to financially provide security and crime-prevention measures.

Moreover, in the present invention, the separate image recording unit is added to the sensor lighting that includes the base body 10, the removable cover body 40 and the light transmission cover 20. Thus, the present invention may be used as the sensor lighting with the recording function. Alternatively, as shown in FIG. 13, if the recording module 50 is removed from the base body 10, and the camera module 60 and the sensor module 70 are removed from the removable cover body 40, the present invention may be used in the same manner as that of the existing general sensor lighting.

According to the present invention, because the sensor lighting with the recording function can have the same shape as that of the typical sensor lighting, a system of sensor lightings can be constructed with a sense of unity in the entirety of a building. Thereby, the present invention can rationally solve the problems of the existing open type surveillance cameras that cause people to feel uncomfortable or defile the appearance of the building.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A sensor lighting with an image recording unit, the sensor lighting comprising: a base body to which an LED light source provided with a converter is mounted; a light transmission cover allowing light emitted from the LED light source to transmit; and a detecting sensor detecting an approaching person, whereby when the detecting sensor detects the approaching person, the LED light source of the base body is turned on so that light emitted from the LED light source is radiated into a target space after passing through the light transmission cover,
wherein a separate removable cover body is coupled to a lower end of the base body in such a way that the light transmission cover is seated onto the removable cover body, and
a recording module is provided in the base body, and a camera module and a sensor module are provided in the removable cover body so that when the sensor module detects the approaching person, the camera module records images, and recorded data produced by the camera module is stored in the recording module.

2. The sensor lighting as set forth in claim 1, wherein an opening cover is hinged to a side surface of the base body, and the recording module is disposed inside the base body at a position corresponding to the opening cover,
wherein a memory card is inserted into or removed from the recording module after the opening cover opens.

3. The sensor lighting as set forth in claim 1, wherein the removable cover body has an inclined portion on a side surface thereof, the inclined portion being reduced in width from a top to a bottom, and the camera module and the sensor module are provided in the inclined portion, whereby the camera module records the images with respect to an inclined direction in response to an angle of the inclined portion.

4. The sensor lighting as set forth in claim 3, wherein locking protrusions are provided on an inner surface of the inclined portion of the removable cover body, each of the locking protrusions being provided with a hook, and the camera module and the sensor module are fastened to the removable cover body by the corresponding locking protrusions.

5. The sensor lighting as set forth in claim 3, wherein the camera module and the sensor module respectively comprise at least two camera modules and at least two sensor modules provided in the inclined portion of the removable cover body such that the camera modules and sensor modules are oriented in different directions, so that the camera modules and sensor modules record images with respect to different directions.
